(19) United States
(12) Patent Application Publication
(10) Pub. No.: US 2006/0253464 A1
(43) Pub. Date: Nov. 9, 2006

(54) Method and system for determining optimum resource allocation in a network

(76) Inventors: Shyamalie Thilakawardana, Guildford (GB); Rahim Tafazolli, Guildford (GB)

Correspondence Address: STITES & HARBISON PLLC, 1199 NORTH FAIRFAX STREET, SUITE 900, ALEXANDRIA, VA, 22314, US

(21) Appl. No.: 10/543,613

(22) PCT Filed: Jan. 23, 2004
(86) PCT No.: PCT/GB04/00293

§ 371 Date: Jan. 12, 2006

(30) Foreign Application Priority Data
Jan. 30, 2003 (GB) 0302215.9

(51) Int. Cl. G06F 7/00

(52) U.S. Cl. 707/100

(57) ABSTRACT

A method for determining the optimum allocation of resources in a mobile telecommunication network. The method includes the step of calculating a fitness parameter for each service class where the fitness parameter is dependent on the quality of service index QoSᵢ, the dynamic queue length q₁, and the frequency of resources f₁, for each service class.

This invention relates to a method and system for controlling the allocation of resources in a mobile telecommunications network.

A mobile telecommunications network has a number of tasks to perform. It must be able to admit a call to or from a terminal and route it via the most efficient path; this may involve a choice of operator or air interface. To do this, the network must be able to keep track of the location of terminals, it must negotiate parameters for the connection and provide some guarantee of service quality during the call. Finally, as the terminal moves the connection must be maintained.

One particular issue the network has to address is the sharing of resources (i.e. channels) between the users of the network. In the radio system, users share a single transmission medium—radio channels. The process of controlling use of this common radio resource is termed ‘resource management’. One of the main concerns related to resource management is the concept of ‘fairness’—users of the network should receive their contracted quality of service irrespective of the service given to the other users of the network.

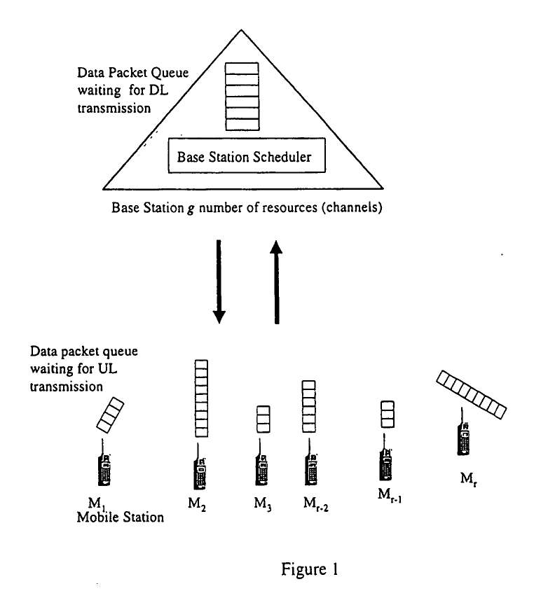

FIG. 1 shows part of a typical mobile telecommunications system. There are a number of mobile users r generating a number of services n (these services include voice traffic, e-mail, mobile Internet, etc.). All of the mobiles are in communication with the base station. The base station has a number of resources (i.e. channels) g available to meet the needs of the users. Typically, n>>g. The scheduler at the base station has to schedule all of these services and control the admission of a call or data service to the system (the Call Admission Control (CAC) process). The number of channels g has to be fairly and efficiently allocated among the service classes. This type of problem is known as combinatorial optimisation since the optimal allocation presents a combination of services among the resources.

Furthermore, the fact that the incoming traffic profile is continuously changing also has to be addressed. The optimum resource allocation is calculated to produce a solution valid for a particular time frame. This calculated solution is only valid for that particular time frame. Once the frame has been refreshed, the resources will have to be reallocated and a new optimum solution calculated for the refreshed frame.

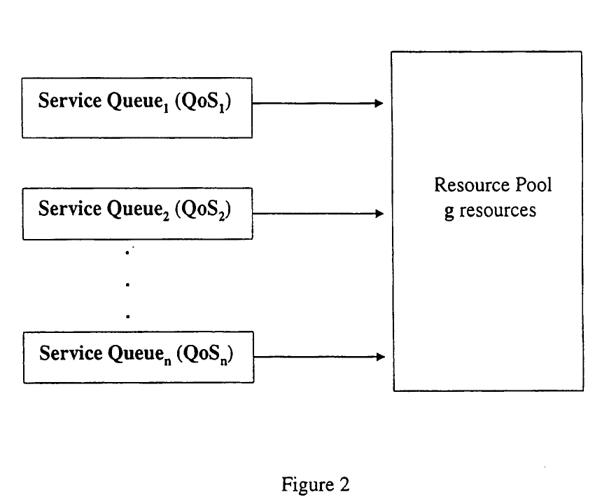

FIG. 2 of the accompanying drawings illustrates schematically the problem of allocating the n diverse service classes having different Quality of Service indices (QoSᵢ . . . QoSₙ) amongst a limited resource pool containing g resources.

According to the invention there is provided a method for determining the optimum allocation of resources amongst a plurality of services classes in a mobile telecommunications network, the method including the step of calculating a fitness function for each service class wherein said fitness function is dependent on a Quality of Service Index of the service class, QoSᵢ, a dynamic queue length qᵢ of the service class and a frequency of resources fᵢ for the service class.

According to the invention there is also provided a method for determining the optimum allocation of resources amongst a plurality of service classes in a mobile telecommunications network, including generating a plurality of different allocations of said resources amongst said service classes, wherein each said allocation forms a respective chromosome of an initial population of chromosomes, and processing said initial population of chromosomes to derive said optimum allocation.

According to the invention there is further provided a call admission control and scheduling system for controlling the allocation of resources amongst a plurality of service classes in a mobile telecommunications network, wherein the system includes scheduling means arranged to derive said optimum allocation from a fitness function for each service class, wherein said fitness function is dependent on a Quality of Service Index QoSᵢ of the service class, a dynamic queue length qᵢ of the service class, and a frequency of resources fᵢ for the service class.

According to the invention there is further provided a call admission control and scheduling system for controlling the allocation of resources amongst a plurality of service classes in a mobile telecommunication network, including scheduling means for generating a plurality of different allocations of said resources amongst said service classes, wherein each said allocation forms a respective chromosome of an initial population of chromosomes, and processing said initial population of chromosomes to derive said optimum allocation.

According to the invention there is further provided a call admission control and scheduling system for controlling the allocation of resources amongst a plurality of service classes in a mobile telecommunications network, including scheduling means arranged to periodically refresh time frames, calculate an optimal solution for a particular time frame, and when the frame is refreshed calculate a new optimal solution for the refreshed frame.

Embodiments of the invention are now described by way of example only, with reference to the accompanying drawings in which;

FIG. 1 shows a schematic mobile telecommunications system,

FIG. 2 shows the problem of scheduling diverse service classes amongst limited resources,

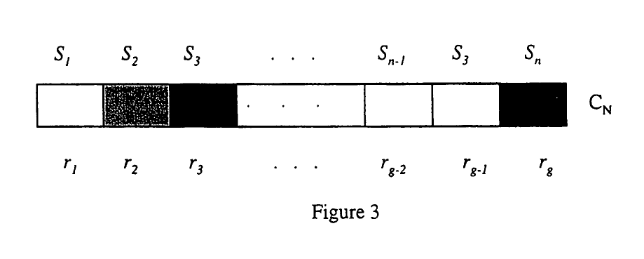

FIG. 3 shows a typical chromosome for use in a genetic algorithm,

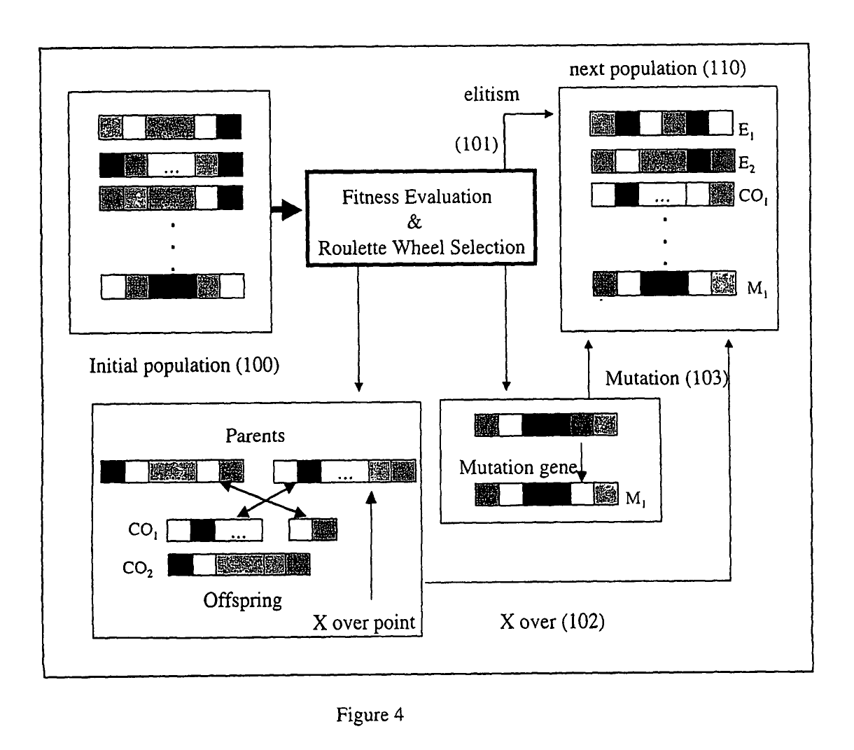

FIG. 4 shows resource assignment using genetic algorithm technique,

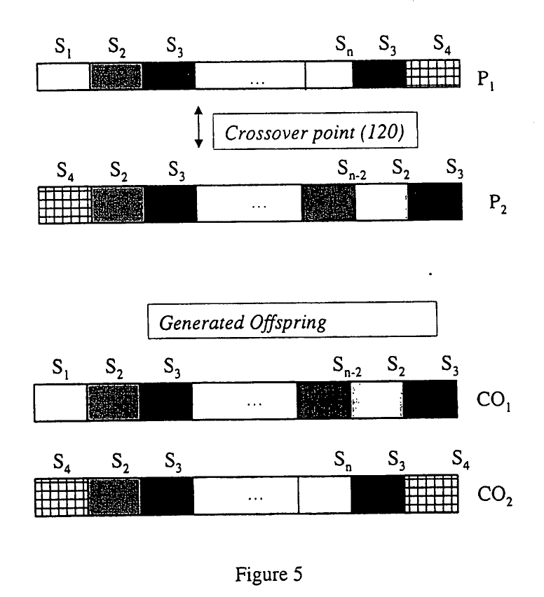

FIG. 5 shows a cross-over operation between two chromosomes to generate offspring chromosomes and

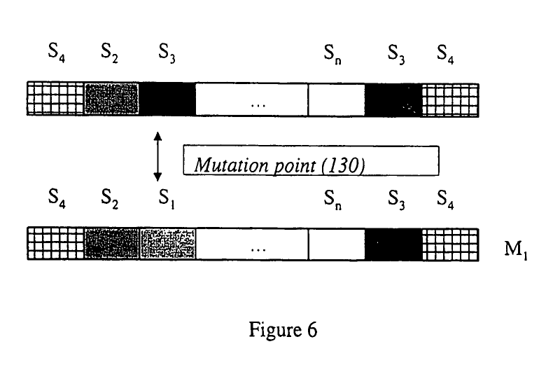

FIG. 6 shows a single mutation point operator on a chromosome.

As will be described, the allocation of resources among the service classes undergoes an evolutionary process, somewhat similar to the evolutionary processes occurring in the field of genetics. Similar terminology to that used in the field of genetics will be adopted here in the description of the invention.

FIG. 3 represents the allocation of g resources among n service classes as a chromosome in a genetic algorithm environment. As the figure shows, the chromosome consists of a number of genes (resources) One possible way of allocating the resources among the service classes is to give one resource each to S₁, Sₙ₋₂, Sₙ₋₁, Sₙ and two resources to S₃. The chromosome shown in FIG. 3 with resources allocated this way represents one of many possible solutions to the allocation of resources among the service classes. Each possible solution will represent a unique chromosome in a search space.

From the many possible solutions a so-called genetic (evolutionary) algorithm is used to produce the optimum solution. The genetic algorithm which calculates the optimum solution includes a parameter known as the FITNESS FUNCTION. The fitness function is used to assess which of the possible solutions is the optimum solution and takes account of parameters such as Quality of Service index, fairness, and queue length distribution. These parameters all need to be reflected in the fitness function. As will be explained, the fitness function is used to assess the survivability of the best chromosomes for carrying over into future populations.

In the genetic algorithm used for call admission control in this system the fitness function is known as the “Call Admission Control and Scheduling Fitness Function” (CACSFF) for optimisation of the population. This particular fitness function is dependent on the Quality of Service Index (QoSᵢ) of the service class, dynamic queue length, qᵢ, of each service class, and the frequency of resources available for each service class fᵢ.

Quality of Service Index QoSᵢ

In currently available scheduling techniques Quality of Service agreement takes account of only one Quality of Service Parameter, for example delay, or priority.

In contrast to such existing systems the Quality of Service agreement used in the present system takes account of a plurality of parameters and is represented as a Quality of Service profile for that service class. This profile is represented as a Quality of Service Index in the fitness function. The idea of a Quality of Service Index measured from several different parameters is a new development in this field.

The Quality of Service Index of each service class depends on a number of different Quality of Service parameters qᵢ′ such as delay, priority and reliability; and the Index reflects the interaction between Quality of Service parameters of each service class. Each of the Quality of Service parameters are graded according to their influence on the Quality of Service Index, for example priority is a more important Quality of Service parameter than delay, so will have more influence on the Quality of Service Index. The Quality of Service Index ranges from 1 to 100, with a Quality of Service Index of 100 being the highest and a Quality of Service Index of 1 being the lowest. Among the Quality of Service Indices for each service class there is a non-linear relationship.

The i^{th} Quality of Service Index (QoSᵢ) is inversely proportional to the particular Quality of Service parameters qᵢ′ contributing to the Index, and the weight of influence of each such parameter decreases according to the square root law; for example, the weight of the highest Quality of Service parameter, q₁ is inversely proportional to the Quality of Service index with weight 1. The next Quality of Service parameter, q₂ is inversely proportional to the Quality of Service index with weight √q₂.

Therefore, the Quality of Service Index QoSᵢ of a service dependent on parameters q₁ and q₂ can be represented as

$${QoS}_{i} = \frac{100}{{q}_{1} \sqrt{{q}_{2}}} \qquad ( 1 )$$

It is clear from the above equation (1) that q₁, has a greater influence on the Quality of Service Index, QoSᵢ than parameter q₂.

Dynamic Queue Length qᵢ

The data services which are required by users of the telecommunication network, such as e-mail, Internet, voice etc. generate traffic that is characterised by periods of alternating high and low traffic loads. This is known as “bursty traffic”. At each particular mobile station and base station the dynamic queue length will vary depending on the burst size distribution of each of the different services. For example, if the required service is the Internet, then the service will have a heavy tailed Pareto distribution. This distribution cannot be very well represented by statistical values such as mean and standard deviation. Alternatively a service such as e-mail will have a Cauchy distribution.

The growing rate of the length of the queue will reflect the call arrival and departure rates, the call duration and the service rate, as well as the properties of each of the particular distributions for the specific services.

The parameter of the dynamic queue length, qᵢ is a measure of queue length at the start of each refreshing frame. The unit of measurement for qᵢ is a constant packet size for all the queues.

Frequency of Resources, fᵢ

fᵢ is the slot frequency in a given frame for the service class i. In the chromosome shown in FIG. 3, two of the possible resources have been allocated to service class S₃. Thus the frequency of resources f₃ for S₃ is 2, whereas for S₁ (and all of the other service classes in the chromosome) the frequency of resources is 1.

Fitness Function fₛᵢ

All of the above three parameters, namely; Quality of Service Index, QoSᵢ, dynamic queue length, qᵢ and frequency of resources fᵢ are used to calculate the fitness function. The fitness function for the i^{th} service class, fₛᵢ is given by:

$${f}_{si} = K [ \frac{{Q}_{i} ⨯ {q}_{i}}{\sqrt{{f}_{i}}} ] \qquad ( 2 )$$

where Qᵢ is the Quality of Service Index of service class i,
qᵢ is the dynamic queue length of the i^{th} service class, and fᵢ is the frequency of resources in the refreshing frame for the i^{th} service class and K is a constant.

From the fitness function, it can be seen that if more resources are allocated to the same service class, √fᵢ will increase and so the value of the fitness function for that service class decreases. Thus the fitness function is biased against exploitation of resources by any one service class.

The above expression is the fitness function for a particular service class. It is also possible to calculate a fitness function C_{f} for the entire chromosome of length g. This is given by the summation

$${C}_{f} = {\sum }_{k = 1}^{k = g} {f}_{si} ( Rj ) , where \qquad ( 3 )$$

Where fₛᵢ(Rj) is the fitness function for the service class I for the j^{th} refreshing frame Rj.

The value Qᵢqᵢ assumes that a higher Quality of Service Index, QoSᵢ, or longer dynamic queue length, qᵢ initiates the allocation of the earliest resource for the specified service. At the same time, to avoid the exploitation of resources by any one service class the inverse square root of fᵢ is included in the fitness function. The optimal solution for the problem of allocation of resources is calculated by using a genetic algorithm.

Use of Genetic Algorithm to Obtain Optimum Solutions

FIG. 4 is a schematic illustration of a genetic algorithm to produce the optimum solution, i.e. the optimum allocation of service classes amongst the available resources during each successive frame. Genetic algorithm operators are involved in finding the optimum solution and using the Call Admission Control and Scheduling Fitness Function to select the survivability among chromosomes in evolutionary populations. To generate the next population standard genetic algorithm techniques are used, namely cross over and mutation techniques. The use of Elitism filters the best chromosome with the highest fitness value. Application of these techniques to the problem is described in detail below.

Step 1

FIG. 3 shows one possible allocation of g resources (r₁, r₂ . . . r_{g}) among n service classes, in a chromosome c of length g. Thus the chromosome has g genes.

Referring again to FIG. 4, an initial population (100) is generated containing N chromosomes C₁, C₂ . . . C_{N}. Each chromosome represents a different allocation of the g resources amongst the n service Classes and the total population consists of all the feasible allocations. The length of each chromosome corresponds to the number of resources, g, available for allocation to the service classes. Each resource is a gene inside the relevant chromosome structure. The fitness function C_{f} for each of the chromosomes is calculated according to equation (3). This population will be referred to as the “first generation” and H (the total number of generations) in set to 1.

Step 2

Look at the fitness function for all of the chromosomes in the initial population (100) and select the 2 chromosomes with the best fitness functions (101). These 2 chromosomes are regarded as “elite” chromosomes and are carried over into the next population (110) as chromosomes E₁ and E₂. This Elitism operation is performed by an Elitism filter and guarantees the transfer of the best chromosome from one generation to the next generation. This process reduces the risk of eliminating best-fit chromosomes at the early stage of the optimisation process.

Step 3

Select two chromosomes from the initial population (100) for a cross-over operation (102). The chromosomes are selected from the initial population by standard roulette wheel selection techniques. The two selected chromosomes are known as parent chromosomes P₁ and P₂. Standard cross-over operations are applied to chromosomes P₁ and P₂ to produce offspring chromosomes CO₁ and CO₂. The offspring chromosomes are forwarded to next population (110).

FIG. 5 shows the cross-over operations between the 2 selected chromosomes P₁ and P₂. In most cases the offspring CO₁, CO₂ of the parent chromosomes P₁ and P₂ have a higher value of fitness or survivability than the parents. The cross-over point (120) is randomly selected at some point in the parent chromosomes.

This cross-over operation on the parent chromosomes is a very potent means of exploring a search space, but it is not without disadvantages. As the cross-over operation proceeds by recombining information from the parents, the generated offspring ideally will only contain genes that were already present in one parent or the other (or both). The genetic algorithm will converge towards a promising region of the search space by progressively eliminating chromosomes having lower values of fitness function. These low survivability candidates having low fitness function values are not passed to the next generation, and are therefore deleted from successive populations.

When the low fitness value chromosomes are eliminated from the population their genetic characteristics are also eliminated from the population. Because of this possibility, important chromosomes are lost from the population and with this cross over operation there would be no way to recover them. The genetic algorithm uses another procedure to overcome this potential problem, this is the use of mutation, discussed in step 4 below.

Step 4

A mutation operator can operate on a chromosome of the initial population to reintroduce chromosomes which may otherwise have been eliminated from the population.

FIG. 6 shows a single point mutation operation on a chromosome from the initial population. The mutation operator proceeds by performing a random modification at mutation point 130 to produce new chromosomes M₁. The mutation point 130 is randomly selected and can be at any point along the chromosome.

In the genetic algorithm a chromosome from the original population (100) is selected by the roulette wheel selection technique. This chromosome is operated on by a mutation operator (103) which performs a random modification at mutation point 130 on the chromosome to produce mutated chromosome M₁. This chromosome is forwarded to the next population (110). Steps 3 and 4 of this process are repeated until the size of the next population is N.

Step 5

If the number of generations H<Hₘₐₓ the algorithm loops back to step 1 and repeats the process on the newly created population until the number of generations reaches Hₘₐₓ. The chromosome having the highest chromosome fitness function C_{f} is then selected from the final generation on the optimum allocation of services amongst the available resources. Hₘₐₓ is typically 1000 say, but could be as small as 2.

Refreshment of Frames

The dynamic nature of the traffic profile of the mobile telecommunications network must be considered to understand the real time problems caused by the traffic characteristics. The concept of “Refresh Frames” is introduced with the solution.

The optimum allocation of resources derived using the genetic algorithm is only valid for the predetermined duration of a frame, referred to given as a ‘refresh frame’. After each refresh frame the available resources must be reallocated according to a new optimum allocation derived using the same genetic algorithm taking account of changes in traffic profile. The concept of refreshing frames in this way provides a dynamic way of studying and estimating real-time traffic characteristics when allocating the g resources among n different service classes in a fair way.

1. A method for determining the optimum allocation of resources amongst a plurality of services classes in a mobile telecommunications network, the method including the step of calculating a fitness function for each service class wherein said fitness function is dependent on a Quality of Service Index of the service class, QoS_{I}, a dynamic queue length qᵢ of the service class and a frequency of resources fᵢ for the service class.

2. A method according to claim 1 wherein said fitness function is proportional to the product of QoSᵢ and qᵢ.

3. A method according to claim 1 wherein said fitness function is inversely proportional to fᵢ

4. A method according to claim 3 wherein said fitness function is proportional to fᵢ^{-1/2}.

5. A method according to claim 1 wherein said Quality of Service Index QoSᵢ is dependent on a plurality of Quality of Service parameters.

6. A method according to claim 5 wherein said Quality of Service parameters include delay, priority and reliability.

7. A method according to claim 6 wherein said Quality of Service parameters are graded according to their influence on the Quality of Service Index.

8. A method according to claim 7 wherein said Quality of Service Index, QoSᵢ is inversely proportional to said Quality of Service parameters.

9. A method according to claim 5 wherein the weight of influence of said Quality of Service parameters decreases according to the square root law.

10. A method according to claim 1 wherein said method uses a genetic algorithm.

11. A method as claimed in claim 1 including generating a plurality of different allocations of said resources amongst said service classes, wherein each said allocation forms a respective chromosome of an initial population of chromosomes, and processing said initial population to derive said optimum allocation.

12. A method as claimed in claim 11 including deriving one or more succeeding population from said initial population and determining said optimum allocation from the final population so derived.

13. A method as claimed in claim 12 including generating for each chromosome of a said population a chromosome fitness function and including in the next succeeding population one or more chromosome having the highest said chromosome fitness function, wherein said chromosome fitness function of a chromosome is derived from the fitness functions for said service classes.

14. A method as claimed in claim 13, including selecting two chromosome of said population, interchanging respective sections, having corresponding resources, of the selected chromosomes to create two new chromosomes, and including the new chromosomes in the next succeeding population.

15. A method as claimed in claim 13 including creating a mutation of a selected chromosome and including the mutation in the next succeeding population.

16. A method as claimed in claim 12 wherein said optimum allocation is determined from successive frames of predetermined duration.

17. A method for determining the optimum allocation of resources amongst a plurality of service classes in a mobile telecommunications network, including generating a plurality of different allocations of said resources amongst said service classes, wherein each said allocation forms a respective chromosome of an initial population of chromosomes, and processing said initial population of chromosomes to derive said optimum allocation.

18. A method as claimed in claim 17 including deriving one or more succeeding population from said initial population and determining said optimum allocation from the final population so derived.

19. A method as claimed in claim 18 wherein each said succeeding population is derived from chromosomes of the immediately preceding population.

20. A method as claimed in claim 19 wherein said optimum allocation is determined for successive frames of predetermined duration.

21. A call admission control and scheduling system for controlling the allocation of resources amongst a plurality of service classes in a mobile telecommunications network, wherein the system includes scheduling means arranged to derive said optimum allocation from a fitness function for each service class, wherein said fitness function is dependent on a Quality of Service Index QoSᵢ of the service class, a dynamic queue length qᵢ of the service class, and a frequency of resources fi for the service class.

22. A call admission control and scheduling system according to claim 21 wherein said fitness function is proportional to the product of QoSᵢ and qᵢ.

23. A call admission control and scheduling system according to claim 21 wherein said fitness function is inversely proportionally to fᵢ.

24. A call admission control and scheduling system according to claim 21 wherein said fitness function is proportional to fᵢ-k.

25. A call admission control and scheduling system according to claim 21 wherein said Quality of Service Index QoSᵢ is dependent on a plurality of Quality of Service parameters.

26. A call admission control and scheduling system according to claim 25 wherein said Quality of Service parameters include delay, priority and reliability.

27. A call admission control and scheduling system according to claim 26 wherein said Quality of Service parameters are graded according to their influence on the Quality of service Index QoSᵢ.

28. A call admission control and scheduling system according to claim 27 wherein said Quality of Service Index is inversely proportional to said Quality of Service parameters.

29. A call admission control and scheduling system according to claim 25 wherein the weight of influence of said Quality of Service parameters decreases according to the square root law.

30. A call admission control and scheduling system according to claim 21 wherein said optimum allocation is derived using a genetic algorithm.

31. A call admission control and scheduling system according to claim 21 wherein said scheduling means is arranged to generate a plurality of different allocations of said resources amongst said service classes, wherein each said allocation forms a respective chromosome of an initial population of chromosomes, and process said initial population to derive said optimum allocation.

32. A call admission control and scheduling system according to claim 31, wherein said scheduling means is arranged to derive one or more succeeding population from said initial population and determining said optimum allocation from the final population so derived.

33. A call admission control and scheduling system according to claim 32 wherein said scheduling means is further arranged to generate for each chromosome of a said population a chromosome fitness function and includes in the next succeeding population one or more chromosome having the highest said chromosome fitness function, wherein said chromosome fitness function of a chromosome is derived from the fitness functions for said service classes.

34. A call admission control and scheduling system according to claim 33, wherein said scheduling means is arranged to select two chromosomes of said population, interchange respective sections, having corresponding resources, of the selected chromosomes to create two new chromosomes, and include the new chromosomes in the next succeeding population.

35. A call admission control and scheduling system according to claim 33 wherein said scheduling means is arranged to create a mutation of a selected chromosome and include the mutation in the next succeeding population.

36. A call admission control and scheduling system according to claim 32 where a said optimum allocation is determined from successive frames of predetermined duration.

37. A call admission control and scheduling system for controlling the allocation of resources between service classes in a mobile telecommunication network, including scheduling means for generating a plurality of different allocations of said resources amongst said service classes, wherein each said allocation forms a respective chromosome of an initial population of chromosomes, and processing said initial population of chromosomes to derive said optimum allocation.

38. A call admission control and scheduling system according to claim 37 wherein said scheduling means is arranged to derive one or more succeeding population from said initial population and to determine said optimum allocation from the final population so derived.

39. A call admission control and scheduling system according to claim 38 wherein each said succeeding population is derived from chromosomes of the immediately preceding population.

40. A call admission control and scheduling system according to claim 39 wherein said optimum allocation is determined for successive frames of predetermined duration.

41. A call admission control and scheduling system for controlling the allocation of resources amongst a plurality of service classes in a mobile telecommunications network, including scheduling means arranged to periodically refresh time frames, calculate an optimal solution for a particular time frame, and when the frame is refreshed calculate a new optimal solution for the refreshed frame.

42. (canceled)

43. (canceled)
